(19) United States
(12) Patent Application Publication
(10) Pub. No.: US 2010/0080965 A1
(43) Pub. Date: Apr. 1, 2010

(54) DISPLAY BLANK BEARING INDICIA

(76) Inventor: Brian P. Reid, Mooresville, NC (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/571,516

(22) Filed: Oct. 1, 2009

Related U.S. Application Data
(60) Provisional application No. 61/101,698, filed on Oct. 1, 2008.

(51) Int. Cl. G09F 7/02; G09F 3/02; G09F 5/00; B44C 1/16; B32B 7/06

(52) U.S. Cl. 428/195.1; 156/249; 428/42.2

(57) ABSTRACT

The invention relates to a display blank bearing indicia such as a pattern for grout, tile, hard wood grain, and granite. The display blank comprises in one embodiment a base sheet, and a substrate bearing the indicia, wherein the substrate is releasably attached to the base sheet. The substrate bearing indicia permits a user to select and apply any number of patterns to a wall, a floor, or a countertop to thereby provide a comprehensive view of the selected pattern on the surface. In another embodiment, the display blank includes a base sheet and substrate that bear indicia, and is appropriate for use as a calendar, a picture frame and image, or a map. In another embodiment, the display blank includes a base sheet and a substrate that bears indicia and an encapsulated fragrance.

### CROSS-REFERENCE TO PRIORITY APPLICATION

This application claims the benefit of and priority to U.S. Provisional Patent Application Ser. No. 61/101,698, filed Oct. 1, 2008, in the U.S. Patent and Trademark Office. This application incorporates the provisional application by reference in its entirety.

### FIELD OF THE INVENTION

The present invention relates to a display blank bearing indicia and associated methods.

### BACKGROUND OF THE INVENTION

The invention relates to a display blank bearing indicia, and more specifically, to a display blank having a base sheet, and a removable reusable substrate bearing the indicia and releasably attached to the base sheet. The substrate may be formed from one or more layers such as a protective layer. The one or more layers of the substrate may be formed from a film, a sheet, or any material capable of forming a layer. The display blank may also be removably attached to any number of surfaces.

As configured, the display blank permits a user to removably attach the display blank carrying any number of indicia to a surface. Further, the display blank permits a user to removably attach the substrate carrying any number of indicia to a surface.

Constructing, decorating, or redecorating a house requires the selection of a variety of materials to complete, for example, flooring, tile, and countertops for bathrooms and kitchens. Known methods of selecting, for example, tile for a bathroom include reviewing a variety of tile patterns, obtaining exemplary patterns, and placing the tile pattern about the bathroom walls and floors. In another example, flooring is selected by reviewing a variety of wood grain patterns, obtaining exemplary patterns, and placing the wood grain patterns on a floor space. In yet another example, countertops are selected by reviewing a variety of granite patterns, obtaining exemplary patterns, and placing the granite patterns on a countertop. These known methods fail to provide the user with a comprehensive view of the resulting pattern once applied to, for example, a countertop. Further, the small swatches or examples of the patterns are often misplaced or lost. Still further, in some instances (e.g., granite patterns) vendors require customers to purchase examples of the patterns.

In another application, the present invention permits a user to more efficiently use and replace calendars and maps. For example, known calendars require a separate sheet member to display the various months in a year. At the end of the year, known calendars are discarded as waste. Known calendars often depict a photograph or image adjacent to the days of the month. Unfortunately, each sheet depicting a month is typically restricted to one image. Even printable calendars require a user to restrict each month with a particular image.

In yet another application, the present invention permits a user to replace maps positioned on a surface (e.g., a wall). Known maps require a separate sheet bearing an image and are often framed. If a user desires another map, the existing map must be removed from a surface (e.g., a wall) and replaced with another map sheet. If the map is framed, then a user must remove and remount the new map in the same or new frame.

In still another application, the subject invention permits a user to decorate a container (e.g., baby bottle) with a removable reusable substrate bearing indicia.

In a further application, an encapsulated fragrance in the form of a liquid laminate coating consisting of a scent-containing slurry may be applied to a desired portion of the substrate. The coating may be applied with a roller. The encapsulated fragrance may be triggered by human activation (i.e., “scratch and sniff”). The invention permits the formation of advertisements for desired fragrances (e.g., perfume) which may be removed and positioned on a desired surface. The substrate bearing the fragrance could be in a shape and bear indicia which match the container which holds the particular fragrance (e.g., a perfume bottle). A user may remove the substrate carrying the encapsulated fragrance from the advertisement, position the substrate on a laptop, compact case, mirror, or other desired surface, and activate the fragrance so that the user may come into contact with the fragrance at desired intervals.

### SUMMARY OF THE INVENTION

The display blank displays any number of indicia and is reusable. The display blank comprises in one embodiment a base sheet, and a substrate bearing the indicia, wherein the substrate is releasably attached to the base sheet. The display blank and/or substrate may be positioned on a wall, a floor, a shelf, a countertop, or any suitable surface.

Image bearing sheets are formed from blanks. It will be understood that as used herein the term “blank” may include rigid paper, flexible plastic, or similar products made of plastic.

In one embodiment, the display blank includes a base sheet, and at least one substrate carried by the base sheet, wherein the substrate is removably attached to the base sheet and bears indicia. The indicia borne by the substrate could include a tile pattern, a grout pattern, a wood grain pattern, or a granite pattern.

In one embodiment the inventive display blank combines the functions of more accurately providing a comprehensive view of a new surface on, for example, a countertop, while efficiently providing an economical means for producing a substrate bearing desired indicia without reliance upon a sample of the actual material to be applied to the surface.

Advantageously, the display blank, and in particular the substrate, is suitable for use in connection with a printer for applying the indicia. In other words, the display blank is capable of receiving printed indicia from any number of available printers. Accordingly, a user can print any number of patterns on the display blank, and more specifically on the substrate. In one embodiment, the display blank and the substrate bear indicia.

The display blank and substrate are removably attachable to a surface. Thus, the display blank and substrate can be applied to any surface (e.g., wall or countertop) and more effectively depict the visual appearance of a particular wall bearing, for example, a specific tile pattern (i.e., the indicia) during construction or new tile pattern during redecorating activities.

In another embodiment, the indicia borne on the display blank and substrate may include indicia such as a calendar, a map, or a photograph. In this embodiment, the display blank is removably attachable to a surface (e.g., wall). Advantageously, the substrate is replaceable with at least another substrate. Accordingly, a display blank depicting a map could be readily replaced with another substrate bearing a different map.

In another embodiment, the display blank facilitates the replacement of an image on a surface while retaining a portion of the display blank for receiving a substrate with a different indicia. For example, the display blank can include a frame design on its outer borders and a removable substrate bearing an image, a calendar, or a map, wherein the substrate can be easily replaced. Thus, the display blank provides a means to display a plurality of indicia in a single location. Moreover, the display blank facilitates the replacement of indicia in an efficient manner.

In another embodiment, an encapsulated fragrance in the form of a liquid laminate coating comprised of a scent-containing slurry is applied to the substrate. The coating may be applied with a roller. The encapsulated fragrance may be triggered by human activation (i.e., “scratch and sniff”). Thus, the display blank may be utilized as an advertisement for desired fragrances (e.g., perfume) which may be removed and positioned on a desired surface. The substrate bearing the fragrance could be in a shape and bear indicia to match the container which holds the fragrance (e.g., a perfume bottle). A user may remove the substrate carrying the encapsulated fragrance from the advertisement, position the substrate on a laptop, compact case, mirror, or other desired surface, and activate the fragrance so that the user may come into contact with the fragrance at desired intervals.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is a top plan view of one embodiment of the invention;

FIG. 2 is a perspective view of a user applying portions of the substrate bearing a pattern of tile and grout to a wall surface;

FIG. 3 is a top plan view of another embodiment of the invention;

FIG. 4 is a perspective view of a user applying the substrate bearing a pattern of granite to a countertop surface;

FIG. 5 is a top plan view of yet another embodiment of the invention;

FIG. 6 is a perspective view of the display blank applied to a wall surface;

FIG. 7 is a perspective view of a user removing a portion of the substrate carried by the base sheet;

FIG. 8 is a perspective view of a portion of the substrate having been removed from the display blank and removably attached to one wall surface, and the display blank removably attached to another wall surface;

FIG. 9 is a perspective view of another embodiment of the invention depicting the substrate removably attached to a container; and

FIG. 10 is a top plan view of the substrate and the substrate removably attached to a container.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

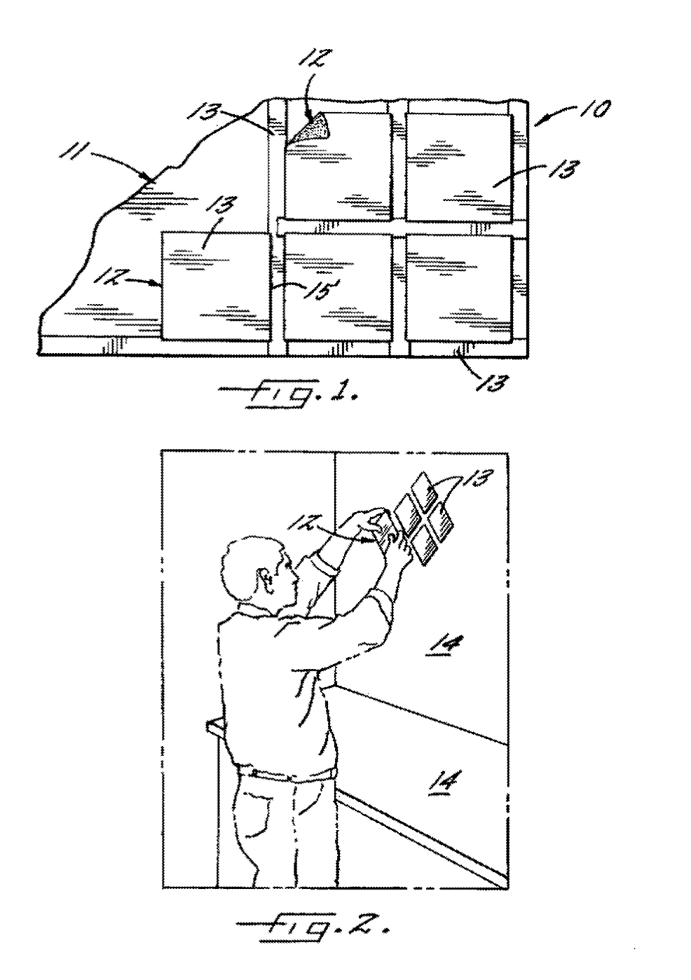

An overall view of one embodiment of a display blank (10) of the invention is set forth in the perspective view of FIG. 1. The display blank (10) bearing a plurality of indicia (13) comprises in one embodiment a base sheet (11), and at least one substrate (12) carried by the base sheet (11). The substrate (12) may be formed from one or more layers such as a protective layer. The one or more layers of the substrate (12) may be formed from a film, a sheet, or any material capable of forming a layer. The substrate (12) is removably attached to the base sheet (11). The display blank (10) and substrate (12) may be removably attached to any number of surfaces. Die-cuts (15) or perforations are optionally provided in the display blank (10) to facilitate removal of portions of the substrate (12) from the base sheet (11).

The base sheet (11) supports the reusable, removable substrate (12) bearing indicia (13). For example, the substrate (12) may be releasably attached to the base sheet (11). Accordingly, the substrate (12) may be removed and replaced with any number of substrates bearing any number of indicia (13).

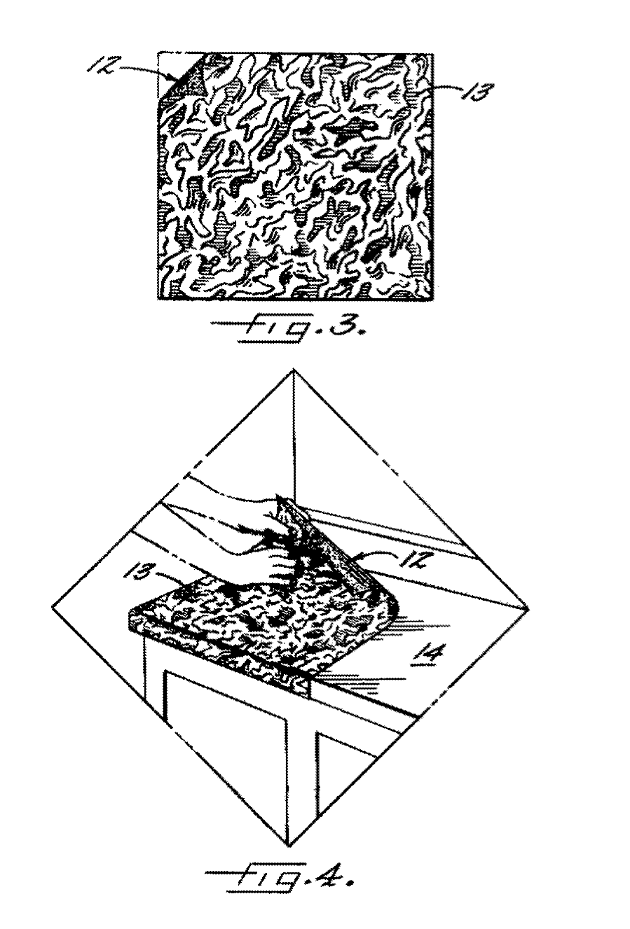

In one embodiment, the substrate (12) bears indicia (13). Advantageously, the display blank (10) is suitable for use in connection with a variety of printers for applying the indicia (13). In other words, the display blank (10) can be loaded into a suitable printer and the substrate (12) can be imprinted with any number of indicia (13) such as a tile pattern, a grout pattern, a wood grain pattern, or a granite pattern (see FIG. 3). Accordingly, a user can print any number of patterns on the display blank (10), and more specifically on the substrate (12).

The substrate (12) bearing indicia (13) is removably attachable to any number of surfaces (14) such as a wall, a countertop, a floor, or the like. Thus, a user can remove the substrate (12) bearing indicia (13) and place the substrate (12) on any number of surfaces (14). For example, a user who is constructing, decorating, or redecorating a house can select a variety of display blanks bearing indicia (13) depicting the appearance of materials to complete, for example, flooring, tile, and countertops for bathrooms and kitchens. As configured, the user can select a display blank (10) bearing a hard wood floor pattern, a tile pattern, or a granite pattern. Next, the user can remove the substrate (12) bearing the pattern (i.e., indicia) and apply the substrate (12) to the surface (14) to be completed. For example, the user can remove the substrate (12) bearing the hard wood grain pattern from the base sheet (11) and apply the substrate (12) to any size portion of a floor.

The user can also remove the substrate (12) bearing the tile and grout pattern from the base sheet (11) and apply the substrate (12) to a bathroom wall or floor. Still further, the user can remove the substrate (12) bearing the granite pattern from the base sheet (11) and apply the substrate (12) to a countertop. By doing so, the user is not limited to the use of a small swatch or piece of granite placed on or adjacent to the floor, wall, or countertop. Use of the inventive display blank (10) bearing indicia (13) provides the user with a comprehensive view of the resulting pattern as applied to a wall, floor, or countertop.

When selecting a desirable pattern, the user can remove the substrate (12) bearing the pattern from the wall, floor, or countertop and reapply it to the base sheet (11) for future use. Thereafter, the user can continue with the selection process until a desirable pattern is found.

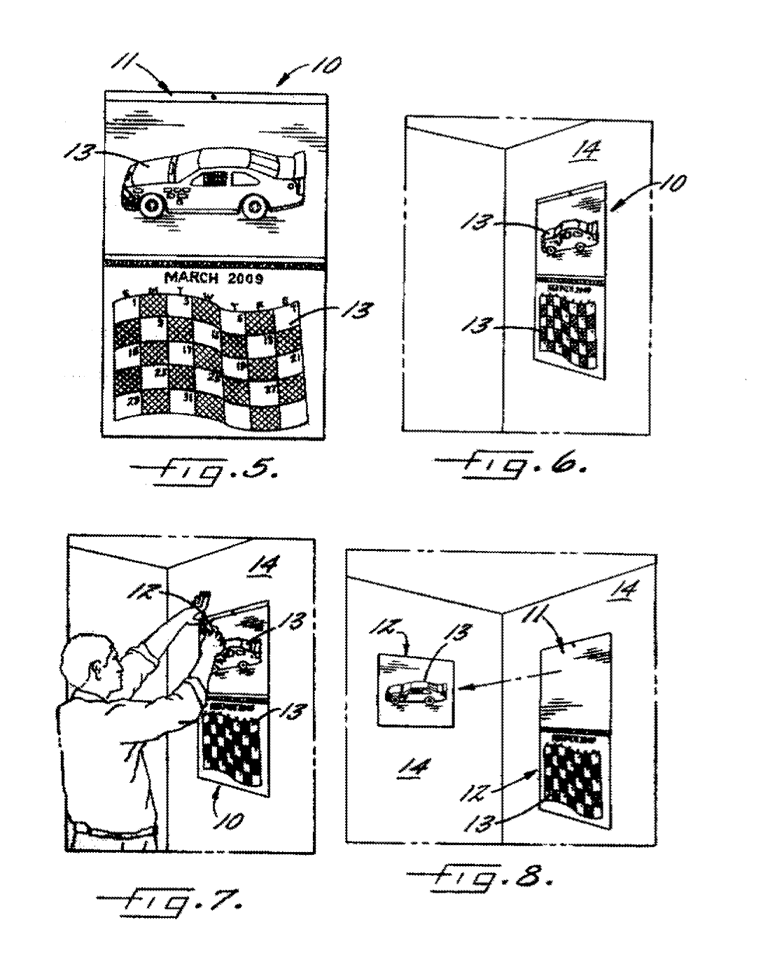

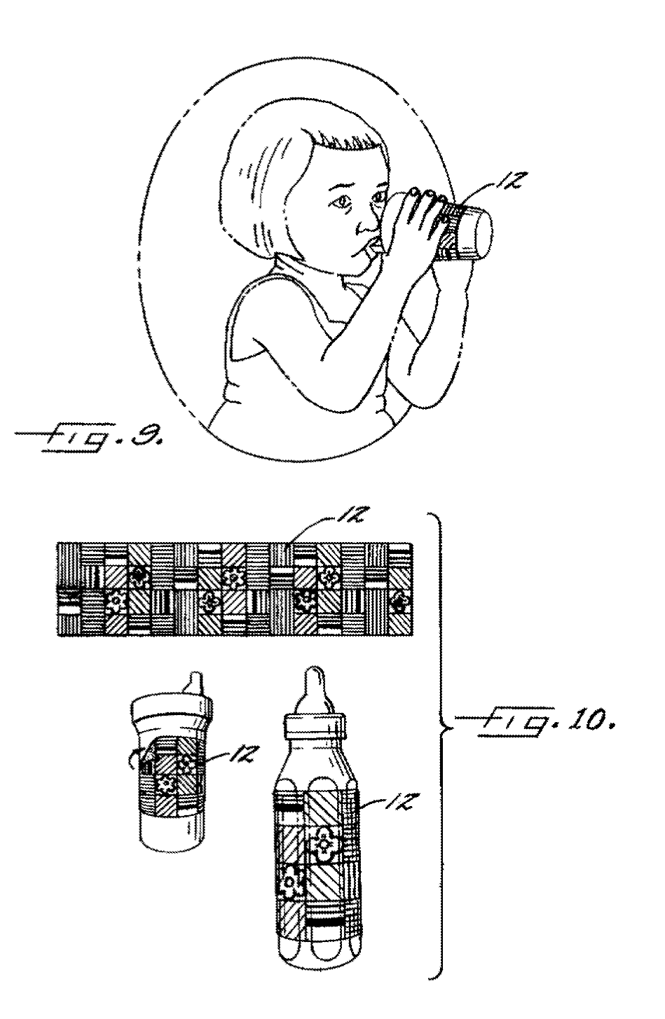

In another embodiment depicted in FIGS. 5-8, the base sheet (11) includes indicia (13) such as a frame design, and the substrate (12) includes indicia (13) such as a calendar, a map, or a photograph. In this embodiment, the display blank (10) is removably attachable to a surface (14) (e.g., a wall) and the substrate (12) is replaceable with at least another substrate (12).

In an embodiment in use as a calendar, the display blank (10) includes multiple substrates bearing indicia (13), wherein the indicia (13) bearing substrates are located substantially adjacent to one another. For example, one substrate (12) could depict the days of the month, and another substrate (12) could depict a seasonal image such as spring flowers or winter snow. Alternatively, one substrate (12) could depict the days of the month, and another substrate (12) could depict an image or photograph of an individual. In this embodiment, the substrate (12) depicting the days of the month could be removed at the end of each month and replaced with a substrate (12) depicting the days of the current month. The other substrate (12) could also be removed and replaced with another image. In this embodiment, the base sheet (11) could remain removably attached to a wall.

In another embodiment, the base sheet (11) would remain on a wall and bear the image of a frame about its borders, and the substrate (12) could be replaced with a variety of images. In yet another embodiment, the base sheet (11) would remain on the wall, and the substrate (12) could bear any number of images of a map. The substrate (12) could be replaced as desired to depict any number of maps.

In another embodiment, an encapsulated fragrance in the form of a liquid laminate coating (20) consisting of a scent-containing slurry is applied to the substrate (12). The coating (20) may be applied to the substrate (12) with a roller. The encapsulated fragrance may be triggered by human activation (i.e., “scratch and sniff”). Thus, the display blank (10) may be utilized as an advertisement for desired fragrances (e.g., perfume) which may be removed and positioned on a desired surface. The substrate (12) bearing the fragrance could be in a shape and bear indicia to match the container which holds the fragrance (e.g., a perfume bottle). A user may remove the substrate (12) carrying the encapsulated fragrance from the advertisement, position the substrate on a laptop, compact case, mirror, or other desired surface, and activate the fragrance so that the user may come into contact with the fragrance at desired intervals.

It will be understood that the base sheet (11) and substrate (12) may be secured to a surface (14) with any number of releasable fasteners, adhesives, releasable glues or the like.

The invention also provides a method of selecting a desired pattern on a surface (14). The steps may include providing a substrate (12) bearing indicia (13), removing the substrate (12) from the base sheet (11), and then releasably attaching the substrate (12) on a desired surface. Thereafter, a user can remove the substrate (12) from the desired surface (14), and then reapply the substrate (12) to the base sheet (11) for future use. The user may repeat the process until a desired pattern for the surface (14) is selected.

During the process of selecting a desired pattern on a surface (14), the indicia (13) may include a tile pattern, a grout pattern, a wood grain pattern, a granite pattern, or any other desirable pattern. The substrate (12) bearing indicia (13) may be releasably attached to a wall, floor, countertop, or any other desired surface (14). Thus, the process allows for the user to effectively depict the visual appearance of, for example, a specific tile pattern (i.e., the indicia) for a particular wall bearing during construction or new tile pattern during redecorating activities.

The indicia (13) may also include a calendar, a map, or a photograph. Thus, the process allows for the user to generate reusable calendars and to select and re-position a variety of maps and photographs.

The substrate (12) used in the method may also bear an encapsulated fragrance in the form of a liquid coating. Accordingly, the process allows for the generation of advertisements for desired fragrances (e.g., perfume) which may be removed and positioned on desired surfaces. The substrate (12) bearing the fragrance could be in a shape and bear indicia to match the container which holds the fragrance (e.g., a perfume bottle). A user may releasably attach the substrate (12) on a laptop, compact case, mirror, or other desired surface, and activate the encapsulated fragrance so that the user may come into contact with the fragrance at desired intervals.

In the drawings and specification, there have been disclosed typical embodiments on the invention and, although specific terms have been employed, they have been used in a generic and descriptive sense only and not for purposes of limitation, the scope of the invention being set forth in the following claims.

That which is claimed is:

1. A display blank bearing indicia comprising:
a base sheet;
at least one substrate carried by said base sheet, said at least one substrate removably attached to said base sheet;
wherein said at least one substrate bears indicia.

2. The display blank of claim 1 wherein said display blank is suitable for use in connection with a printer for applying said indicia.

3. The display blank of claim 1 wherein said display blank is removably attachable to a surface.

4. The display blank of claim 1 wherein said base sheet bears indicia.

5. The display blank of claim 1 wherein said at least one substrate is replaceable with at least another substrate.

6. The display blank of claim 1 wherein said at least one substrate is suitable for use in connection with a printer for applying said indicia.

7. The display blank of claim 1 wherein said substrate is removably attachable to a surface.

8. The display blank of claim 1 wherein said indicia is selected from the group consisting of a tile pattern, a grout pattern, a wood grain pattern, and a granite pattern.

9. The display blank of claim 1 wherein said indicia is a calendar, a map, or a photograph.

10. The display blank of claim 1 wherein said display blank includes die-cuts facilitating the removal of said substrate from said base sheet.

11. The display blank of claim 1 wherein said at least one substrate bears an encapsulated fragrance.

12. The display blank of claim 11, wherein in said encapsulated fragrance is in the form of a liquid coating.

13. The display blank of claim 11, wherein said encapsulated fragrance is in the form of a slurry containing a desired scent.

14. A method of selecting a desired pattern on a surface comprising the steps of:
providing at least one substrate releasably carried by a base sheet, the at least one substrate bearing desired indicia;
removing the at least one substrate bearing indicia from the base sheet; and
releasably attaching the at least one substrate bearing indicia on a desired surface.

15. The method of claim 14, wherein the indicia is selected from the group consisting of a tile pattern, a grout pattern, a wood grain pattern, and a granite pattern.

16. The method of claim 14 wherein the indicia is selected from the group consisting of a calendar, a map, and a photograph.

17. The method of claim 14 wherein the base sheet and at least one substrate includes die-cuts facilitating the removal of the at least one substrate from the base sheet.

18. The method of claim 14 wherein the at least one substrate bears an encapsulated fragrance.

19. The method of claim 14 further comprising the steps of:
removing the at least one substrate bearing indicia from the desired surface; and
reapplying the at least one substrate bearing indicia to the base sheet for future use;
wherein the steps of removing and reapplying are accomplished after the step of releasably attaching.

20. The method of claim 19 wherein the steps are accomplished until a user selects a desired pattern for the surface.
